(19) United States
(12) Patent Application Publication
(10) Pub. No.: US 2012/0262596 A1
(43) Pub. Date: Oct. 18, 2012

(54) IMAGE FOCUSING DEVICES AND METHODS FOR CONTROLLING AN IMAGE FOCUSING DEVICE

(75) Inventors: Juergen HAAS, Marchtrenk (AT); Andreas GSTOETTNER, Linz (AT); Manfred MEINDL, Linz (AT); Andreas WASSERBAUER, Pettenbach (AT)

(73) Assignee: INFINEON TECHNOLOGIES AG, Neubiberg (DE)

(21) Appl. No.: 13/088,478

(22) Filed: Apr. 18, 2011

(51) Int. Cl. G06K 9/40; H04N 5/228

(52) U.S. Cl. 348/222.1; 382/255; 348/E05.024

(57) ABSTRACT

According to various embodiments, an image focusing device may be provided. The image focusing device may include an image acquirer configured to acquire digital data representing an image. The image focusing device may further include a region selector configured to receive information indicating a first region of the image and indicating a second region of the image. The second region may be different from the first region. The image focusing device may further include an image deconvolver configured to iteratively apply deconvolutions to the first region and to the second region. A stopping criterion for the iterative application of the deconvolutions may be based on a focusing quality of the deconvolved first region and is independent from the deconvolved second region.

### TECHNICAL FIELD

Embodiments relate generally to image focusing devices and methods for controlling an image focusing device.

### BACKGROUND

In imaging systems, it may be desired to take images in focus. If a lens or imaging system is out of focus, the taken images may look blurred, and thus it may be hard to detect details of the taken image.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an image focusing device in accordance with an embodiment;

FIG. 2 shows an image focusing device in accordance with an embodiment;

FIG. 3 shows a flow diagram illustrating a method for controlling an image focusing device in accordance with an embodiment;

FIG. 4 shows an image focusing device in accordance with an embodiment;

FIG. 5 shows a flow diagram illustrating a method for controlling an image focusing device in accordance with an embodiment;

FIG. 6 shows an image focusing device in accordance with an embodiment;

FIG. 7 shows an image focusing device in accordance with an embodiment;

FIG. 8 shows an image focusing device in accordance with an embodiment;

FIG. 9 shows an image focusing device in accordance with an embodiment; and

FIGS. 10A and 10B show an example of an image and a deconvolved image in accordance with an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any embodiment or design described herein as “exemplary” is not necessarily to be construed as preferred or advantageous over other embodiments or designs.

The image focusing device communication device may include a memory which may for example be used in the processing carried out by the image focusing device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific communication device may also hold for any communication device described herein. It will be understood that any property described herein for a specific method may also hold for any method described herein.

In imaging systems, it may be desired to take images in focus. If a lens or imaging system is out of focus, the taken images may look blurred, and thus it may be hard to detect details of the taken image.

In commonly used imaging systems, to get in-focus images, autofocus-lens systems or so called fixed-focus systems may be used. Autofocus systems may use (for example like the human eye) a mechanically adjustable lens system combined with a measurement mechanism, which may determine the sharpness or focus of the object to view, to deliver an in focus result. Fixed-focus systems may utilize that for lens systems, it may be possible to adjust them in a way that images are nearly in focus for a very wide depth range. There may be only one focal point, but the focus-error may be very small for most of the range after the focal point and there may still be significant bluffing caused by de-focus before that focal point. The fixed-focus approach still may have some image quality issues, whereas the autofocus approach may add additional cost to an imaging system. Furthermore commonly used auto-focus systems may be mechanical systems, thus they may be rather slow and error prone due to their mechanic nature.

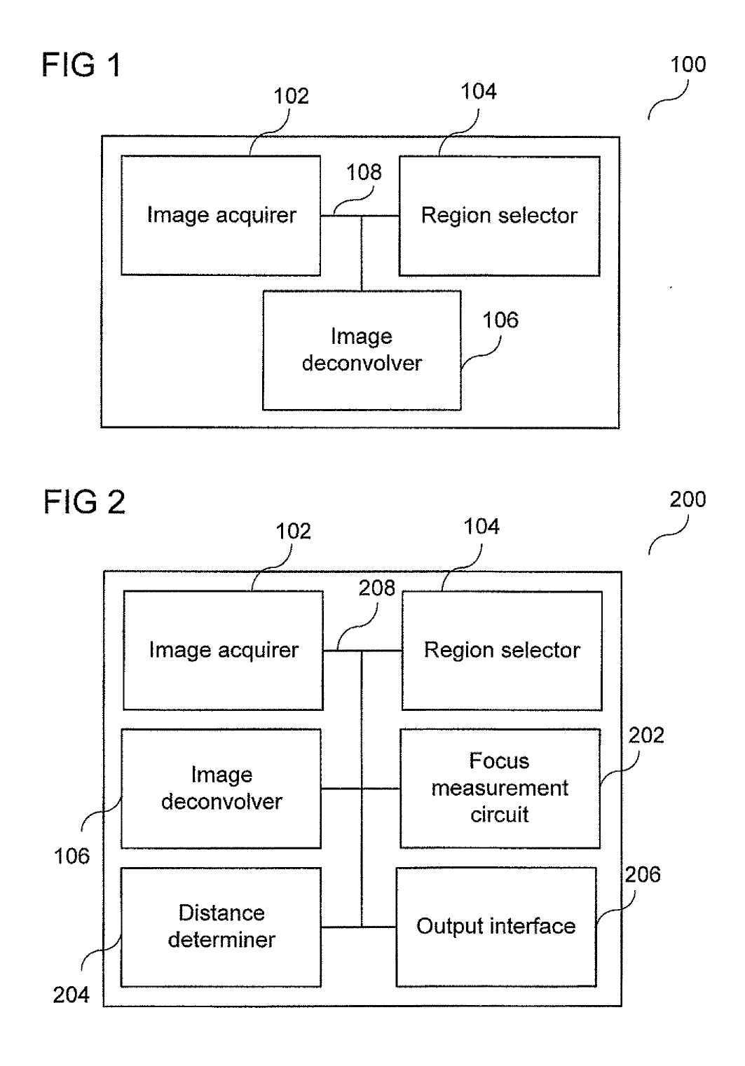

FIG. 1 shows an image focusing device 100 in accordance with an embodiment. The image focusing device 100 may include an image acquirer 102 configured to acquire digital data representing an image. The image focusing device 100 may further include a region selector 104 configured to receive information indicating a first region of the image and indicating a second region of the image. The second region may be different from the first region. The image focusing device 100 may further include an image deconvolver 106 configured to iteratively apply deconvolutions to the first region and to the second region. A stopping criterion for the iterative application of the deconvolutions may be based on a focusing quality of the deconvolved first region and may be independent from the deconvolved second region. The image acquirer 102, the region selector 104, and the image deconvolver 106 may be coupled with each other, e.g. via an electrical connection 108 such as e.g. a cable or a computer bus or via any other suitable electrical connection to exchange electrical signals.

According to various embodiments, the first region may be a region of the image including an object on which the image is to be focused.

According to various embodiments, the image acquirer 102 may further be configured to automatically determine the first region. According to various embodiments, the image acquirer 102 may further be configured to determine the first region based on an input by a user of the image focusing device.

FIG. 2 shows an image focusing device 200 in accordance with an embodiment. The image focusing device 200 may, similar to the image focusing device 100 shown in FIG. 1, include an image acquirer 102. The image focusing device 200 may, similar to the image focusing device 100 shown in FIG. 1, include a region selector 104. The image focusing device 200 may, similar to the image focusing device 100 shown in FIG. 1, include an image deconvolver 106. The image focusing device 200 may further include a focus measurement circuit 202, like will be described in more detail below. The image focusing device 200 may further include a distance determiner 204, like will be described in more detail below. The image focusing device 200 may further include an output interface 206, like will be described in more detail below. The image acquirer 102, the region selector 104, the image deconvolver 106, the focus measurement circuit 202, the distance determiner 204, and the output interface 206 may be coupled with each other, e.g. via an electrical connection 208 such as e.g. a cable or a computer bus or via any other suitable electrical connection to exchange electrical signals.

According to various embodiments, the focus measurement circuit 202 may be configured to measure a focusing quality of the deconvolved first region.

According to various embodiments, the image deconvolver 106 may further be configured to apply deconvolutions including a deconvolution with an inverse point spread function.

According to various embodiments, the image deconvolver 106 may further be configured to acquire the inverse point spread function from a table of inverse point spread functions.

According to various embodiments, the image deconvolver 106 may further be configured to acquire the inverse point spread function from a table of inverse point spread functions based on a distance of an object to be focused.

According to various embodiments, the image deconvolver 106 may further be configured to acquire the inverse point spread function based on a computation model and a distance of an object to be focused.

According to various embodiments, the distance determiner 204 may be configured to determine a distance of an object to be focused.

According to various embodiments, the image deconvolver 106 may further be configured to apply a series of deconvolutions to the first region and to the second region, and the stopping criterion may be a criterion including a criterion of the focusing quality of the deconvolved first region deconvolved with the present deconvolution is worse than the focusing quality of the deconvolved first region with the preceding deconvolution.

According to various embodiments, the series of deconvolutions may include or may be a series of deconvolutions of a table of deconvolutions.

According to various embodiments, the series of deconvolutions may include or may be a series of deconvolutions determined based on a computational model and a series of distances of an object to be focused.

According to various embodiments, the stopping criterion may include or may be a criterion of that the focusing quality of the first region is optimal according to an optimality criterion.

According to various embodiments, the optimality criterion may include or may be a criterion of being optimal among a plurality of deconvolutions.

According to various embodiments, the optimality criterion may include or may be a criterion of being above a pre-determined threshold.

According to various embodiments, the output interface 206 may be configured to output a deconvolved image.

According to various embodiments, the deconvolved image may be deconvolved by a deconvolution applied corresponding to the stopping criterion.

According to various embodiments, the output interface 206 may be configured to output the deconvolved image to a monitor (not shown).

According to various embodiments, the output interface 206 may be configured to output the deconvolved image to a storage (not shown).

According to various embodiments, the image focusing device 200 may be configured to be operated in a digital photo camera (not shown).

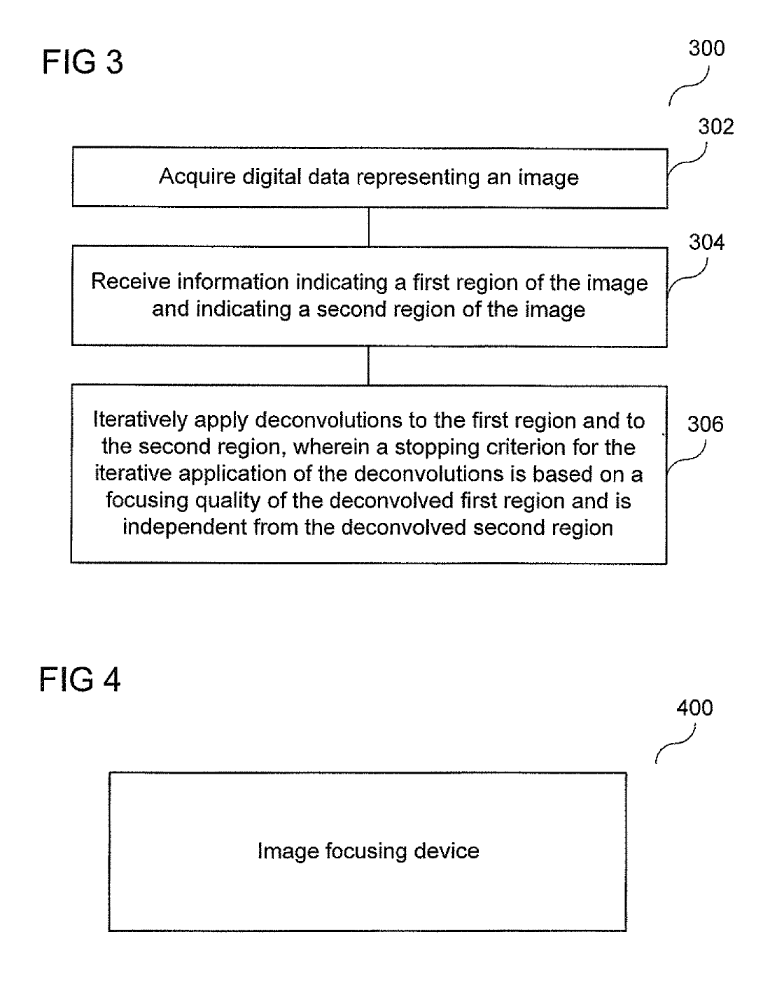

FIG. 3 shows a flow diagram 300 illustrating a method for controlling an image focusing device in accordance with an embodiment. In 302, digital data representing an image may be acquired. In 304, information indicating a first region of the image and indicating a second region of the image may be received. The second region may be different from the first region. In 306, deconvolutions may iteratively be applied to the first region and to the second region. A stopping criterion for the iterative application of the deconvolutions may be based on a focusing quality of the deconvolved first region and may be independent from the deconvolved second region.

According to various embodiments, the first region may be a region of the image including an object on which the image is to be focused.

According to various embodiments, the first region may automatically be determined. According to various embodiments, the first region may be determined based on an input by a user of the image focusing device.

According to various embodiments, a focusing quality of the deconvolved first region may be measured.

According to various embodiments, the deconvolutions may be or may include a deconvolution with an inverse point spread function.

According to various embodiments, the inverse point spread function may be acquired from a table of inverse point spread functions.

According to various embodiments, the inverse point spread function may be acquired from a table of inverse point spread functions based on a distance of an object to be focused.

According to various embodiments, the inverse point spread function may be acquired based on a computation model and a distance of an object to be focused.

According to various embodiments, a distance of an object to be focused may be determined.

According to various embodiments, a series of deconvolutions may be applied to the first region and to the second region. According to various embodiments, the stopping criterion may be a criterion being or including a criterion of the focusing quality of the deconvolved first region deconvolved with the present deconvolution is worse than the focusing quality of the deconvolved first region with the preceding deconvolution.

According to various embodiments, the series of deconvolutions may include or may be a series of deconvolutions of a table of deconvolutions.

According to various embodiments, the series of deconvolutions may include or may be a series of deconvolutions determined based on a computational model and a series of distances of an object to be focused.

According to various embodiments, the stopping criterion may include or may be a criterion of that the focusing quality of the first region is optimal according to an optimality criterion.

According to various embodiments, the optimality criterion may include or may be a criterion of being optimal among a plurality of deconvolutions.

According to various embodiments, the optimality criterion may include or may be a criterion of being above a pre-determined threshold.

According to various embodiments, a deconvolved image may be outputted.

According to various embodiments, the deconvolved image may be deconvolved by a deconvolution applied corresponding to the stopping criterion.

According to various embodiments, the deconvolved image may be output to a monitor.

According to various embodiments, the deconvolved image may be output to a storage.

According to various embodiments, the method may be configured to be executed in a digital photo camera.

FIG. 4 shows an image focusing device 400 in accordance with an embodiment. The image focusing device 400 may include an image deconvolver configured to iteratively apply deconvolutions to a first region of an image being different from a second region of the image, until a focusing quality of the deconvolved first region fulfils a pre-determined criterion, independent from the deconvolved second region.

FIG. 5 shows a flow diagram 500 illustrating a method for controlling an image focusing device in accordance with an embodiment. In 502, deconvolutions may iteratively be applied to a first region of an image being different from a second region of the image, until a focusing quality of the deconvolved first region fulfils a pre-determined criterion, independent from the deconvolved second region.

According to various embodiments, a fully digital auto-focus mechanism may be provided.

According to various embodiments, deconvolution (or deconvolving) may be a digital image processing approach to revert bluffing (and other effects) in an image. This approach may be utilized to revert bluffing induced by the imaging system being out of focus. According to various embodiments, deconvolution regarding image processing may mean that an image may be inversely convolved (or convoluted) by a Point-Spread-Function (PSF). According to various embodiments, a PSF based on an inverse approach, a Wiener approach, a Lucy-Richards approach and/or a sparse approach may be used. This PSF may be the error induced to the, in theory perfect, imaging system path. This error may be determined or measured by an iterative measurement approach.

According to various embodiments, an in-focus image may be acquired from the proper PSF for it. Such a deconvolution system may be combined with measurement and adjustment methods may replace or enhance a commonly used auto-focus or fixed-focus system. According to various embodiments, devices may be provided at a lower cost compared to a mechanical system. According to various embodiments, in case of a full digital system a higher speed and faster focusing times than a mechanical AF system may be provided.

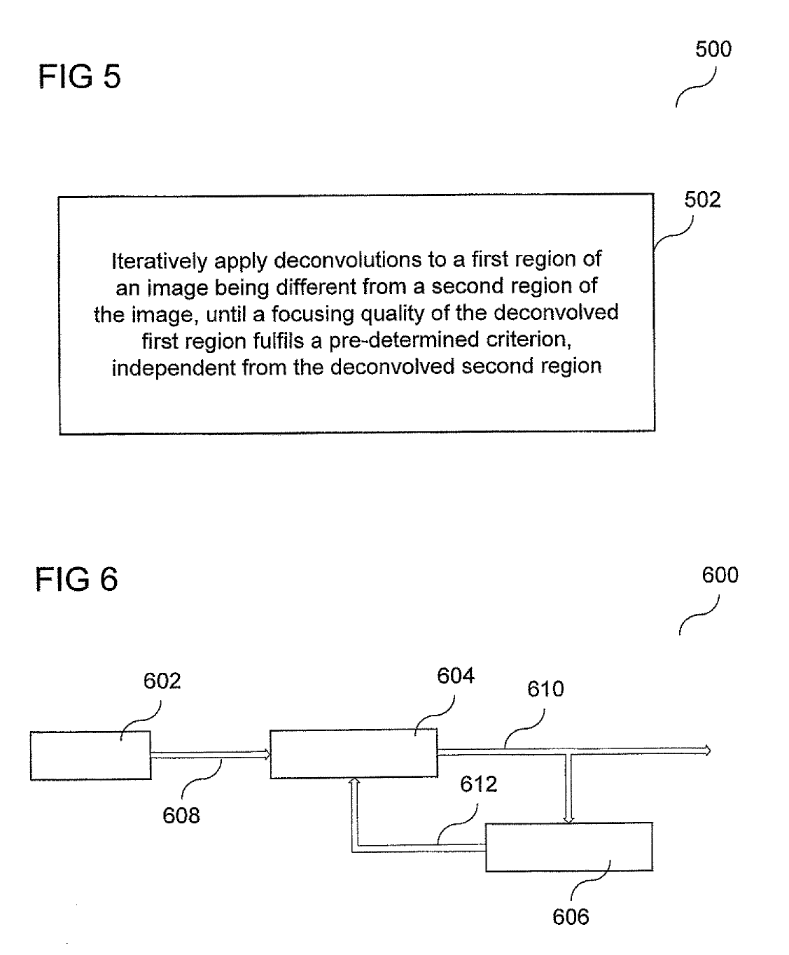

FIG. 6 shows an image focusing device 600 in accordance with an embodiment. An imaging device 602 (or an imaging system) may send a source image 608 to a deconvolver 604 (for example an image deconvolver). A deconvolved image 610 may be sent to a focus measurement circuit 606. The focus measurement circuit may send a measurement feedback 612 to the deconvolver 604 to adjust deconvolution.

According to various embodiments, devices and methods may be provided to determine a given image system (for example determine the PSF for different focal distances) or to utilize a deterministic or iterative approach and to use this information in a digital measurement loop to generate an in-focus image.

According to various embodiments, what in commonly used AF (auto-focus) systems is done via an optical lens system (for example getting an image or part of the image in focus by trying different lens positions and measuring the result) may be performed via a digital deconvolution block.

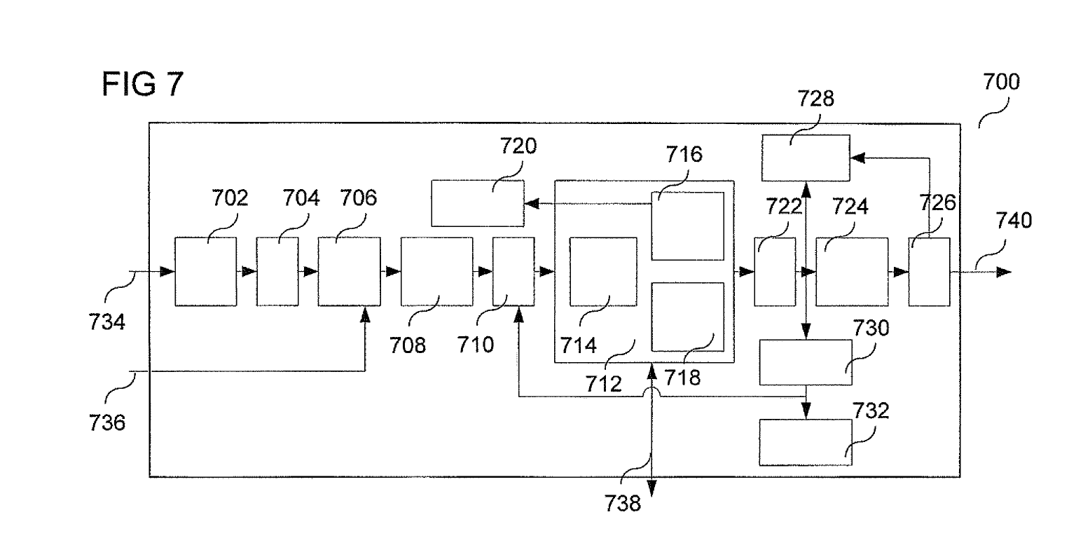

FIG. 7 shows an image focusing device in accordance with an embodiment, for example included in an RGB (red-green-blue) Bayer signal processing arrangement 700. Bayer signal processing may be provided to obtain color images from a black-and-white-sensor by utilizing color filters. In the end a final pixel may be interpolated from a 4×4 matrix containing a red, two green and one blue pixel. Since the human eye is most sensitive to the green light spectrum, twice the green information may be used. RGB Bayer data 734 may be input to a bad pixel corrector 702. The output of the bad pixel corrector 702 may be input to a black level circuit 704. The output of the black level circuit 704 may be input to a sensor de-gamma circuit 706. BL (black level) measurement and corrections data 736 may also be provided (for example on a data line of 12 bits) to the sensor de-gamma circuit 706. According to various embodiments, an offset may be provided to a value that provides black. The output of the sensor de-gamma circuit 706 may be input to a lens shade corrector 708. The output of the lens shade corrector 708 may be input to an automatic white balance (awb) circuit 710. The output of the awb circuit 710 may be provided to a processing arrangement 712. The processing arrangement 712 may include a deconvolver 714, a Bayer interpolator 718, and a filter 716 (for example for filtering noise, for sharpening, or for bluffing). The output of the filter 716 may be provided to an auto focus measurement circuit 720, for example on a data line of 8 bits. The processing arrangement 712 may be connected to an SPRAM (signal processing random access memory) interface 738, for example a line buffer. The output of the processing arrangement 712 may be provided to a cross talk (X-talk) circuit 722, for example on a data line of 3×12 bits. The output of the cross talk circuit 722 may be provided to a gamma out circuit 724. The output of the gamma out circuit 724 may be provided to a CSM circuit 726 for CSM (Color Space Matrix) or multiplication, which may provide a matrix multiplication that may convert RGB to YCbCr (wherein Y may be a luma component, Cb may be a blue-difference component, and Cr may be a red-difference chroma component), and 4:2:2 conversion, for example on a data line of 3×10 bits. The output of the CSM circuit 726 may be provided to a histogram measurement circuit 728, for example on a line of 4 bits, and may be output, for example on a data line 740 of 2×10 bits. The histogram circuit 728 may exchange information with an CSM fixed circuit 730, for example on a line of 3×4 bits. The output of the CSM fixed circuit 730 may be provided to the awb circuit 710 and to an auto exposure measurement circuit 732.

According to various embodiments, devices and methods may be based on a feedback loop, for example a software (SW) feedback loop. For example, in a camera interface, a deconvolution block may be placed in the Bayer Pattern Image Signal Processing (ISP) path, like described above, and may act as a preprocessing block to the Bayer interpolation and filtering. In this path, there may be a line buffer which may enable the matrix based (for example a 5×5 Bayer pattern) deconvolution.

According to various embodiments, processing in the time-domain (for example at least for small filter windows) may be a more efficient compared to a frequency-domain variant due to the higher complexity and hence additional area of the needed DFT (discrete Fourier transformation) blocks, but processing in the frequency-domain may induce artifacts on the border area regions of the image.

According to various embodiments, the deconvolved image may be passed to an adjacent processing chain, for example including to the autofocus measurement block (AFM) 720. The results of the AFM may be read. Those results may then be evaluated and the deconvolution block may be reprogrammed accordingly for the next image.

According to various embodiments, the evaluation and reconfiguration in this loop may be done between two adjacent frames or images, but if the complexity of those calculations is too high, or the performance of the device is too low, one or more frames may be skipped.

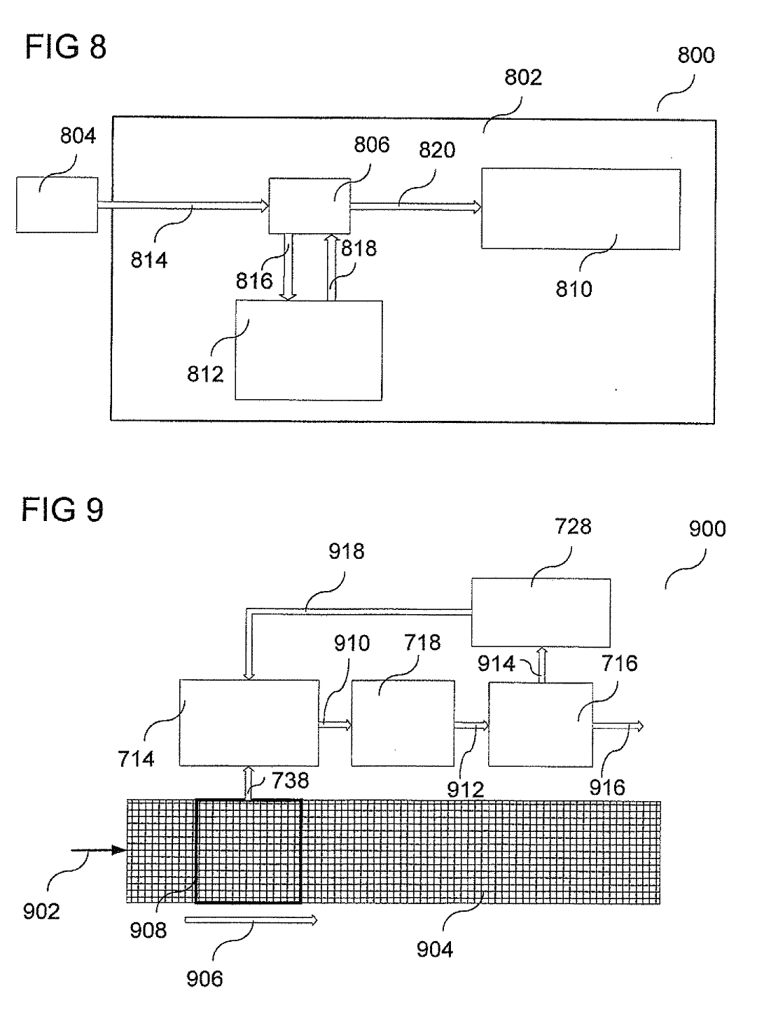

FIG. 8 shows an image focusing device 800 in accordance with an embodiment, for example including a processing system 802. A sensor 804 may provide an image 814 to a camera interface 806. AFM data 816 may be provided to a processing circuit 812, for example a central processing unit. Deconvolution information 818 may be provided from the processing circuit 812 to the camera interface 806. A processed image 820 may then be stored in a memory 810. According to various embodiments, AFM evaluation and deconvolution may be performed between two frames or images in the so called vertical blanking time.

According to various embodiments, deconvolution may be used for image restoration after an image has been acquired.

According to various embodiments, a deconvolver may be provided as a part in a hardware image signal processing (ISP) unit. According to various embodiments, real time processing while receiving the image data from the sensor may be provided, and already existing ISP infrastructure (for example hardware buffers, other processing, statistics and measurement blocks) may be reused, which may lead to an area and cost effective design.

FIG. 9 shows an image focusing device 900 in accordance with an embodiment. Various portions of the image focusing device 900 may be similar or identical to the signal processing arrangement 700 of FIG. 7, and the same reference signs may be used and duplicate description may be omitted.

In an ISP processing pipe, various portions (for example for Bayer interpolation and/or for filtering) may work on image sub-windows or matrices. To allow such operations, a line buffer (for example image line buffer) 904 may be provided to store the pixel image data or line data, which may be sequentially sent image data. From this buffer 904, the data may then get processed in a sliding window or matrix manner The size of those buffers may increase with the image size and the size of the used computation window 908 and regarding silicon area it may be one of the main contributors of the whole ISP. A deconvolution may be similar to the inverse filtering of an image with a known transfer-function, and it may also rely on such a buffer which may be reused when integrated in the hardware ISP. The line buffer 904 may be filled pixel after pixel and line by line, like indicated by arrow 902. The computation window 906 may slide through the buffer with the last input pixel, like indicated by arrow 906. Output 910 of the deconvolver 714 may be provided to the Bayer interpolation circuit 718. Output 912 of the Bayer interpolation circuit 718 may be provided to the filter 716. The filter may output filtered data 916 and may provide filtered data 914 to the auto focus measurement circuit 728. Output 918 of the auto focus measurement circuit 728 may be provided to the deconvolver 714 and may thus provide feedback to adjust or control the deconvolution settings.

According to various embodiments, an already available circuit may be re-used in combination with the deconvolution, for example the utilization of the autofocus measurement circuit to find the proper deconvolution settings regarding the image area of interest or focus. This may be an iterative regulation process where the interaction between the measurement and deconvolution circuit, as well as the speed of the computation will be taken into account.

According to various embodiments, devices and methods may be provided for digital real-time deconvolution auto-focus applications. According to various embodiments, the devices and methods will be cheaper, faster and without the vulnerability inherent to mechanical systems.

According to various embodiments, the deconvolver may be placed directly in the ISP, and the deconvolver may be positioned at the sweet spot of the processing chain, between circuits that enhance the image quality of the deconvolver and circuits that would degrade the quality or increase the complexity of the deconvolution. For example, if applying deconvolution on an image after a common ISP (for example delivering YCbCr 4:2:2), then the pixel data may already be transformed and reduced, hence transformations (and for example reduction) may lead to information loss so that the result of the deconvolution may be not as good as when applied before those transformations.

According to various embodiments, processing according to the devices and methods described above may be provided in the ISP, and this may directly work with the sensor data (for example a raw Bayer pattern), which was only transformed by blocks which lead to no or only to desired (for example by bad pixel correction) information loss.

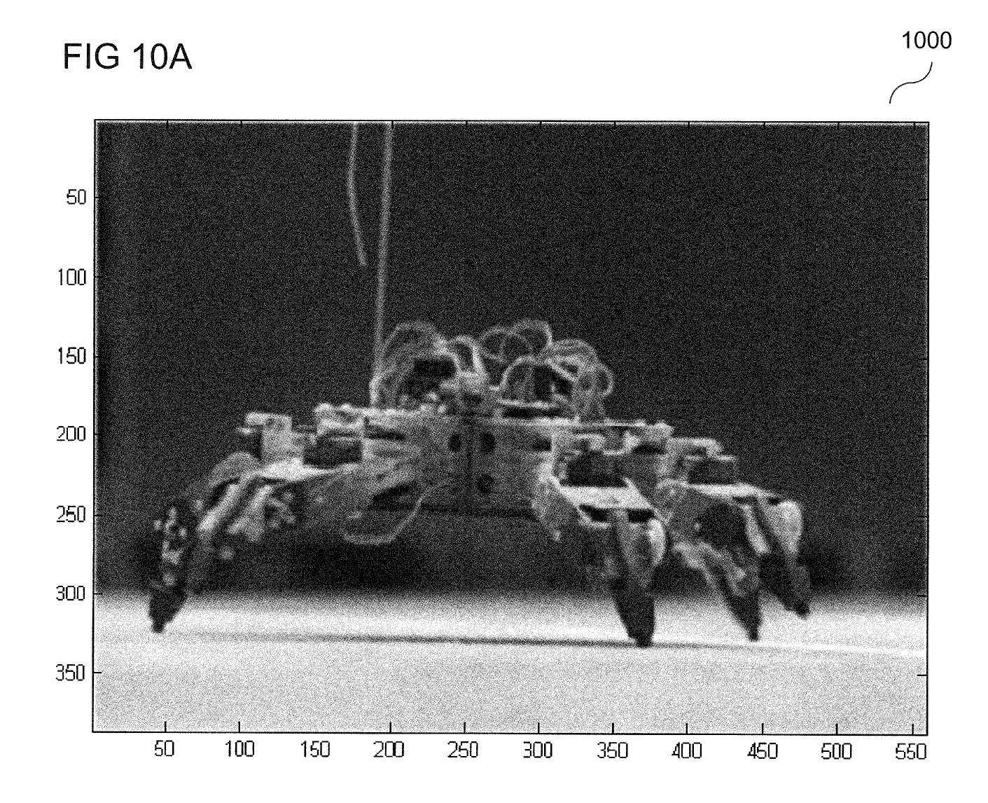

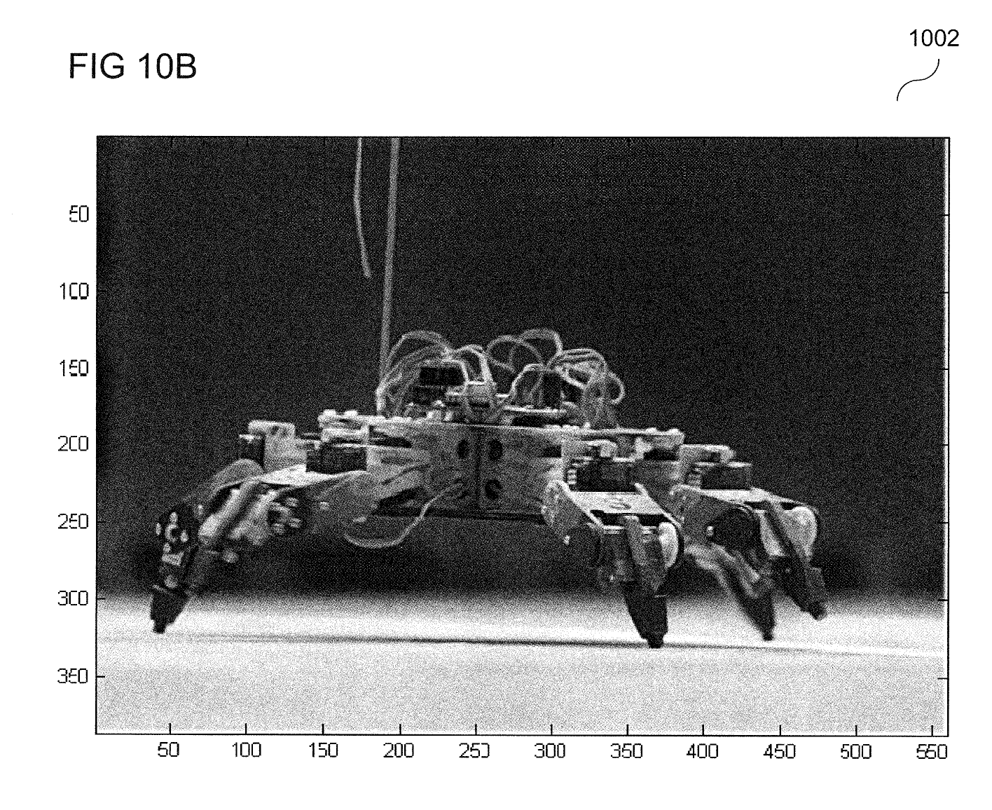

FIGS. 10A and 10B show an example of an image and a deconvolved image in accordance with an embodiment. In FIG. 10A, a first image 1000 with a blurred or defocused scene is shown. In FIG. 10B, a second image 1002 showing the deconvoluted (in other words: filtered) image according to various embodiments is shown, which is significantly sharper hence looking more detailed.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An image focusing device, comprising:
an image acquirer configured to acquire digital data representing an image;
a region selector configured to receive information indicating a first region of the image and indicating a second region of the image, wherein the second region is different from the first region; and
an image deconvolver configured to iteratively apply deconvolutions to the first region and to the second region, wherein a stopping criterion for the iterative application of the deconvolutions is based on a focusing quality of the deconvolved first region and is independent from the deconvolved second region.

2. The image focusing device of claim 1,
wherein the first region is a region of the image including an object on which the image is to be focused.

3. The image focusing device of claim 1, further comprising:
a focus measurement circuit configured to measure a focusing quality of the deconvolved first region.

4. The image focusing device of claim 1,
wherein the image deconvolver is further configured to apply deconvolutions comprising a deconvolution with an inverse point spread function.

5. The image focusing device of claim 4,
wherein the image deconvolver is further configured to acquire the inverse point spread function from a table of inverse point spread functions.

6. The image focusing device of claim 5,
wherein the image deconvolver is further configured to acquire the inverse point spread function from a table of inverse point spread functions based on a distance of an object to be focused.

7. The image focusing device of claim 4,
wherein the image deconvolver is further configured to acquire the inverse point spread function based on a computation model and a distance of an object to be focused.

8. The image focusing device of claim 1, further comprising:
a distance determiner configured to determine a distance of an object to be focused.

9. The image focusing device of claim 1,
wherein the image deconvolver is further configured to apply a series of deconvolutions to the first region and to the second region, and wherein the stopping criterion is a criterion comprising a criterion of the focusing quality of the deconvolved first region deconvolved with the present deconvolution is worse than the focusing quality of the deconvolved first region with the preceding deconvolution.

10. The image focusing device of claim 1,
wherein the stopping criterion comprises a criterion of that the focusing quality of the first region is optimal according to an optimality criterion.

11. The image focusing device of claim 1, further comprising:
an output interface configured to output a deconvolved image.

12. The image focusing device of claim 1,
being configured to be operated in a digital photo camera.

13. A method for controlling an image focusing device, the method comprising:
acquiring digital data representing an image;
receiving information indicating a first region of the image and indicating a second region of the image, wherein the second region is different from the first region; and
iteratively applying deconvolutions to the first region and to the second region, wherein a stopping criterion for the iterative application of the deconvolutions is based on a focusing quality of the deconvolved first region and is independent from the deconvolved second region.

14. The method of claim 13,
wherein the first region is a region of the image including an object on which the image is to be focused.

15. The method of claim 13, further comprising:
wherein the deconvolutions comprise a deconvolution with an inverse point spread function.

16. The method of claim 15, further comprising:
acquiring the inverse point spread function from a table of inverse point spread functions.

17. The method of claim 16, further comprising:
acquiring the inverse point spread function from a table of inverse point spread functions based on a distance of an object to be focused.

18. The method of claim 15, further comprising:
acquiring the inverse point spread function based on a computation model and a distance of an object to be focused.

19. The method of claim 13, further comprising:
determining a distance of an object to be focused.

20. The method of claim 13, further comprising:
applying a series of deconvolutions to the first region and to the second region, and wherein the stopping criterion is a criterion comprising a criterion of the focusing quality of the deconvolved first region deconvolved with the present deconvolution is worse than the focusing quality of the deconvolved first region with the preceding deconvolution.

21. The method of claim 13,
wherein the stopping criterion comprises a criterion of that the focusing quality of the first region is optimal according to an optimality criterion.

22. The method of claim 13, further comprising:
outputting a deconvolved image.

23. The method of claim 13,
being configured to be executed in a digital photo camera.

24. An image focusing device, comprising:
an image deconvolver configured to iteratively apply deconvolutions to a first region of an image being different from a second region of the image, until a focusing quality of the deconvolved first region fulfils a pre-determined criterion, independent from the deconvolved second region.

25. A method for controlling an image focusing device, the method comprising:
iteratively applying deconvolutions to a first region of an image being different from a second region of the image, until a focusing quality of the deconvolved first region fulfils a pre-determined criterion, independent from the deconvolved second region.
